(19) United States
(12) Patent Application Publication
(10) Pub. No.: US 2006/0150125 A1
(43) Pub. Date: Jul. 6, 2006

(54) Methods and systems for interface management

(76) Inventors: Arun Gupta, Noida ( U.P. ) (IN); Anku Jain, Noida ( U.P. ) (IN); Vikram Salwan, Noida ( U.P. ) (IN); Neeraj Sharma, Noida ( U.P. ) (IN); Chin-Hwa Hu, Sijhih City (TW); Jl Lee, Banciao City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/301,654

(22) Filed: Dec. 13, 2005

Related U.S. Application Data
(60) Provisional application No. 60/641,100, filed on Jan. 3, 2005.

(51) Int. Cl. G06F 17/00

(52) U.S. Cl. 715/864

(57) ABSTRACT

A method for interface management employed in a portable electronic device is provided. A category screen identity (ID) is received from a function resident in an application layer. The category screen ID corresponds to one screen layout among multiple screen layouts. Drawing detail corresponding to the received category screen ID is determined. An interface is drawn contingent upon the determined drawing detail on a display of the portable electronic device.

### BACKGROUND

The invention relates to a user interface (UI), and more particularly, to methods and systems for interface management employed in portable electronic devices.

Applications in mobile stations contains various functions each of which may involve various computer logic such as retrieving data in various format from memory or storage devices, calculating data to generate specific results, representing data via various interface layouts. Such various logic, however, are mixed in a single function, and different functions may use common interface layouts to represent data and/or interact with users. Thus, when common interface layouts are revised, all corresponding computer code in numerous functions must be revised.

### SUMMARY

Methods for interface management employed in portable electronic devices are provided. An exemplary embodiment of a method performs the following steps. A category screen identity (ID) is received from a function resident in an application layer. The category screen ID corresponds to one screen layout among multiple screen layouts. Drawing detail corresponding to the received category screen ID is determined. An interface is drawn contingent upon the determined drawing detail on a display of the portable electronic device.

As the screen layout comprises a user interface (UI) element control. The method may further support actual string acquisition and perform the following steps. A string ID is received from the function. An actual string corresponding to the received string ID is acquired. The acquired string is drawn on the UI element control in the interface.

As the screen layout comprises a UI element control, the method may further support string acquisition for multi-languages and performs the following steps. A string ID is received from the function. One string database is determined among multiple string databases. Each string database stores the actual strings in one language among multiple languages. An actual string corresponding to the received string ID is acquired from the determined string database. The acquired string is drawn on the UI element control in the interface.

As the screen layout comprises a UI element control. The method may further support image data acquisition and perform the following steps. An image ID is received from the function. Actual image data corresponding to the received image ID is acquired. An image corresponding to the acquired image data is drawn on the UI element control in the interface.

As the screen layout comprises a menu control, the method may further support menu data acquisition and perform the following steps. A menu ID is received from the function. Actual menu data corresponding to the received menu ID is acquired. The menu control corresponding to the acquired menu data is drawn in the interface. The menu control is utilized to browse multiple menu items therein and call a particular function resident in the application layer when one of the menu items is selected. The acquired menu data may comprise menu item data belonging to the received menu ID. The menu item data corresponding to the menu item comprises a string ID or an image ID. An actual string corresponding to the received string ID is acquired. Actual image data corresponding to the received image ID is acquired. The acquired string and an image corresponding to the acquired image data is drawn on the menu item.

The method may further support run-time variable caching for the current interface and perform the following steps. Multiple run-time variables utilized in the currently displayed interface are acquired before determining the drawing details. The acquired run-time variables are cached in a data structure in a last-in-first-out (LIFO) basis.

The method may further support run-time variable caching and roll-back for the prior interface and perform the following steps. It is determined that the function ID is the same as a caller function ID cached in the top of a data structure in a LIFO basis. Multiple run-time variables corresponding to caller function ID are acquired from the top of the data structure. The interface is drawn contingent upon the acquired run-time variables.

The method may further support determination of UI element controls and drawing details thereof in the category screen and perform the following steps. First information regarding that a UI element control is contained in the interface corresponding to the received category screen ID is acquired. The interface containing the UI element control is drawn contingent upon the acquired first information. Second information regarding that the UI element control is located at a specific location is acquired. The UI element control at the location is drawn contingent upon the acquired second information. Third information regarding that the UI element control is displayed using a UI theme parameter affecting the “look and feel” of the interface is acquired. The UI element control using the UI theme parameter is drawn contingent upon the acquired third information. The UI theme parameter may be a background color, a font color, a border style or a font style.

In order to support multiple themes, the method may further comprise the following steps. First information regarding that a UI element control is contained in the interface corresponding to the received category screen ID is acquired. The interface containing the UI element control is drawn contingent upon the acquired first information. One UI theme database is determined among multiple UI theme databases. Each UI theme database stores second information regarding that the UI element control is displayed using a UI theme parameter affecting the “look and feel” of the interface. The UI theme parameter is acquired from the determined UI theme database. The UI element control is drawn using the UI theme parameter contingent upon the second acquired information.

A machine-readable storage medium storing a computer program which, when executed by a portable electronic device, performs the method for interface management is also provided.

Systems for interface management employed in portable electronic devices are provided. An embodiment of an interface management system comprises an application layer and a category manager. The application layer comprises multiple functions. The category manager receives a screen ID from one function, determines drawing details corresponding to the received category screen ID, and draws an interface contingent upon the determined drawing details on a display of the portable electronic device. The category screen ID corresponds to one screen layout among multiple screen layouts.

As the screen layout comprises a UI element control, in order to support actual string acquisition, the category manager may receive a string ID from the function, acquire an actual string corresponding to the received string ID and draw the acquired string on the UI element control in the interface. The actual string may be acquired from a string database comprising a string map table and a string data table via a string management sub-module. The string data table comprises the string reference by an index, and the string map table comprises a mapping between the index and the actual string. The string management sub-module may acquire the index corresponding to the received string ID from the string map table and acquire the actual string corresponding to the acquired index from the string data table.

As the screen layout comprises a UI element control, in order to support string acquisition for multi-languages, the category manager may receive a string ID from the function, determine one string database among multiple string databases, acquire an actual string corresponding to the received string ID from the determined string database and draw the acquired string on the UI element control in the interface. Each string database stores the actual strings in one language among multiple languages.

As the screen layout comprises a UI element control, in order to support image data acquisition, the category manager may receive an image ID from the function, acquire actual image data corresponding to the received image ID and draw an image corresponding to the acquired image data on the UI element control in the interface. The actual image data may be acquired from an image database comprising an image map table and an image data table via an image management sub-module. The image data table comprises the image data reference by an index, and the image map table comprises a mapping between the index and the actual image data. The image management sub-module acquires the index corresponding to the received image ID from the string map table and acquires the actual image data corresponding to the acquired index from the image data table.

As the screen layout comprises a menu control, in order to support menu data acquisition, the category manager may receive a menu ID from the function, acquire actual menu data corresponding to the received menu ID and draw the menu control corresponding to the acquired menu data in the interface. The menu control is utilized to browse multiple menu items therein and call a particular function resident in the application layer when one of the menu items is selected. The acquired menu data may comprise menu item data belonging to the received menu ID. The menu item data corresponds to one of the menu items comprising a string ID or an image ID. The category manager may acquire an actual string corresponding to the received string ID, acquire actual image data corresponding to the received image ID and draw the acquired string and an image corresponding to the acquired image data on the corresponding menu item.

In order to support run-time variable caching for the current interface, the category manager may acquire multiple run-time variables utilized in the currently displayed interface before determining the drawing details, and cache the acquired run-time variables in a data structure in a LIFO basis.

In order to support run-time variable caching and roll-back for the prior interface, the category manager may determine that the function ID is the same as a caller function ID cached in the top of a data structure in a LIFO basis, acquire multiple run-time variables corresponding to caller function ID from the top of the data structure and draw the interface contingent upon acquired run-time variables.

In order to support determination of UI element controls and drawing details thereof in the category screen, the category manager may acquire first information regarding that a UI element control is contained in the interface corresponding to the received category screen ID and draw the interface containing the UI element control contingent upon the acquired first information. The category manager may further acquire second information regarding that the UI element control is located at a specific location, and draw the UI element control at the location contingent upon the acquired second information. The category manager may further acquire third information regarding that the UI element control is displayed using a UI theme parameter affecting the “look and feel” of the interface, and draw the UI element control using the UI theme parameter contingent upon the acquired third information. The UI theme parameter may be a background color, a font color, a border style or a font style.

In order to support multiple themes, the category manager may acquire first information regarding that a UI element control is contained in the interface corresponding to the received category screen ID and draw the interface containing the UI element control contingent upon the acquired first information. The category manager may further determine one UI theme database among multiple UI theme databases. Each UI theme database stores second information regarding that the UI element control is displayed using a UI theme parameter affecting the “look and feel” of the interface. The category manager acquires the UI theme parameter from the determined UI theme database and draws the UI element control using the UI theme parameter contingent upon the acquired second information.

### DESCRIPTION OF THE DRAWINGS

The invention will become more fully understood by referring to the following detailed description of embodiments with reference to the accompanying drawings, wherein:

FIGS. 1a and 1b are diagrams of two exemplary category screens;

FIG. 2 is a diagram of software architecture of an embodiment of an interface management system;

FIG. 3 is a flowchart showing an embodiment of a method for interface management;

FIG. 4 is a diagram of three exemplary string databases supporting a multi-language feature;

FIG. 5 is a diagram of an exemplary conceptual table containing mappings between string IDs and actual strings in different languages;

FIG. 6 is a diagram of an exemplary image database;

FIG. 7 is a diagram of an exemplary menu database;

FIGS. 8a and 8b are diagrams of tree structures of exemplary menu items in various aspects;

FIG. 9 is a diagram illustrating a menu to be displayed corresponding to an exemplary UI buffer;

FIG. 10a is an exemplary sequence diagram for caching run-time variables in an MMI;

FIG. 10b is an exemplary sequence diagram for restoring run-time variables in the previously cached MMI;

FIG. 11 is a diagram of an exemplary control database;

FIG. 12 is a diagram of an exemplary coordinate database;

FIG. 13 is a diagram of three exemplary theme databases supporting a multi-theme feature;

FIG. 14 is a diagram of exemplary switchings between two MMIs;

FIG. 15 is a diagram of software architecture of an embodiment of an interface management system;

FIG. 16 is a diagram of an exemplary layer structure;

FIG. 17 is a diagram of a storage medium storing a computer program providing an embodiment of a method for interface management.

### DESCRIPTION

Methods for interface management employed in portable electronic devices are provided. Moreover, those skilled in the art will understand that some embodiments may be practiced with other portable electronic devices having displays, including PDAs (digital personal assistants), MP3 players, portable disk drives, programmable consumer electronics, portable multimedia players (PMP), and the like.

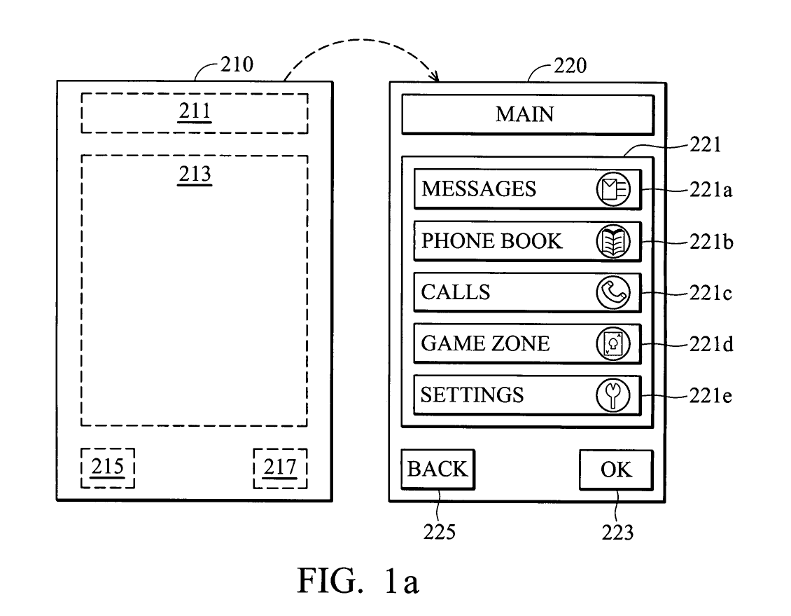

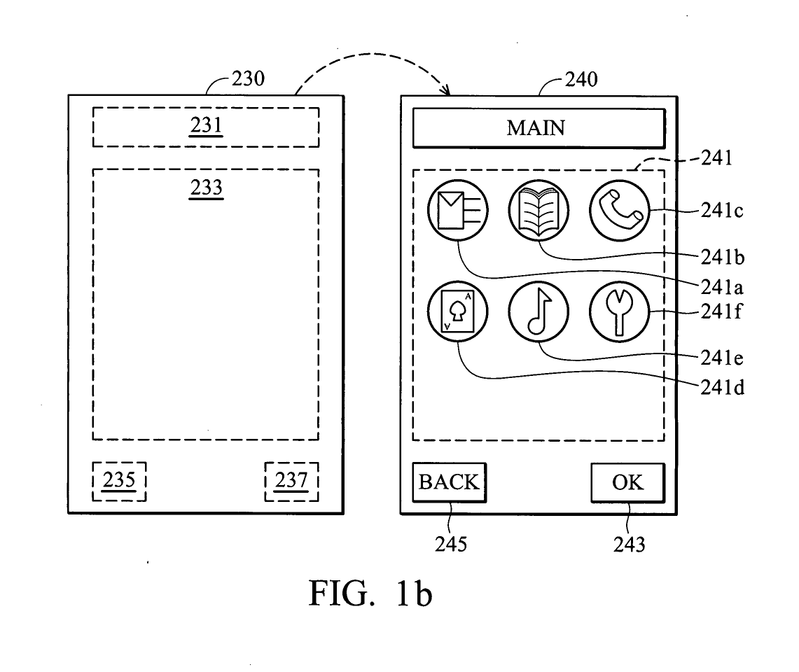

The MMI (man-machine interface) layout is displayed on a display of the portable electronic device based on various category screens. A category screen contains at least one display region, and each display region contains at least one user interface (UI) element control. Three preliminary types of data contained in UI element controls, such as strings, images and menus may be selectively contained in a display region. FIGS. 1a and 1b are diagrams of exemplary category screens 210 and 230. Referring to FIG. 1a, the category screen 210 contains four regions 211, 213, 215 and 217. The region 211 contains a string for displaying a title of a specific MMI (man-machine interface) layout. The region 213 contains a menu utilized to provide entries to several functions. The menu contains multiple list items, and, each list item contains a string and an image for display and corresponds to a particular function such as a “messages”, “calls”, phone book, game zone, “settings” manager, image viewer, mp3 player, quick search or similar, by various intrinsic association links. The regions 215 and 217 respectively contains two soft keys for prompting users to enter a specific function associated with the selected menu item, or return to the previous MMI layout. An exemplary MMI layout 220 for a main menu associates with the category screen 210. The region 213 displays a main menu 221 containing five list items 221a to 221e.

Referring to FIG. 1b, the category screen 230 contains eight regions 231, 233, 235 and 237. The region 231 contains a string for displaying a title of a specific MMI layout. The region 233 contains a menu utilized to provide entries to several functions. The menu contains multiple circular graphic items, and each graphic item contains an image for display and corresponds to a particular function such as a “messages”, “calls”, phone book, game zone, “settings” manager, image viewer, mp3 player, quick search or similar, by various intrinsic association links. The regions 235 and 237 respectively contains two soft keys for prompting users to enter a specific function associated with the selected graphic item, or return to the previous MMI layout. An exemplary MMI layout 240 for a main menu associates with the category screen 230. The region 233 displays a main menu 241 containing six circular graphic items 241a to 241f.

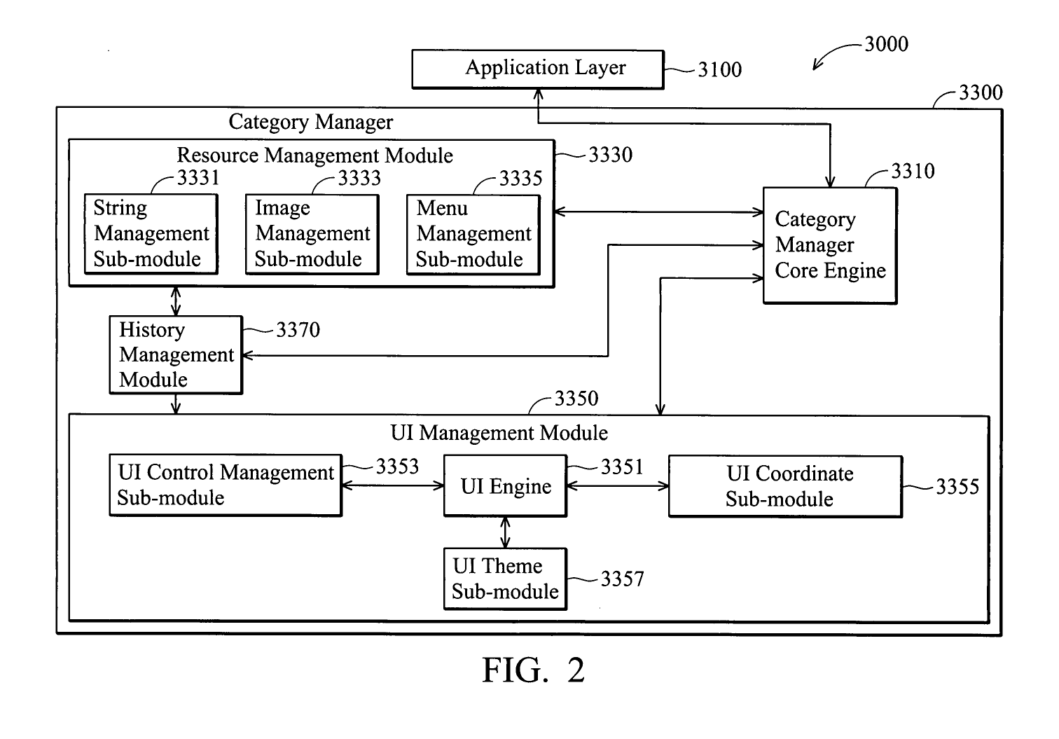

FIG. 2 is a diagram of the software architecture of an embodiment of an interface management system, comprising an application layer 3100 and a category manager 3300. The category manager 3300 comprises a category manager core engine 3310, a resource management module 3330, a UI management module 3350 and a history management module 3370. The resource management module 3330 comprises a string management sub-module 3331, an image management sub-module 3333 and a menu management sub-module 3335. The UI management module comprises a UI engine 3351, a UI control management sub-module 3353, a UI coordinate sub-module 3355, and a UI theme sub-module 3357.

When a specific MMI layout is required to be drawn on a display of the portable electronic device (not shown), a function, such as a “calls” function, a “messages” function, a phone book function, and so on, resident in the application layer 3100 makes a drawing function call with relevant drawing parameters to the category manager 3300, and subsequently, the category manager 3300 accordingly draws the specific MMI layout on the display. The drawing parameters may comprise information regarding that a function identity (ID), a category screen ID, and string IDs corresponding to predefined strings, image IDs corresponding to predefined images, and/or menu ID corresponding to a predefined menu item set. It will be understood that the application layer 3100 only provides relevant data and/or data pointers for multiple UI element controls contained in a particular category screen to the category manager 3300, and the category manager 3300 assumes full responsibility in considering drawing details such as display coordinates, background and font colors, font styles and the like, for UI element controls, and draws the MMI layout corresponding to the category screen on the display.

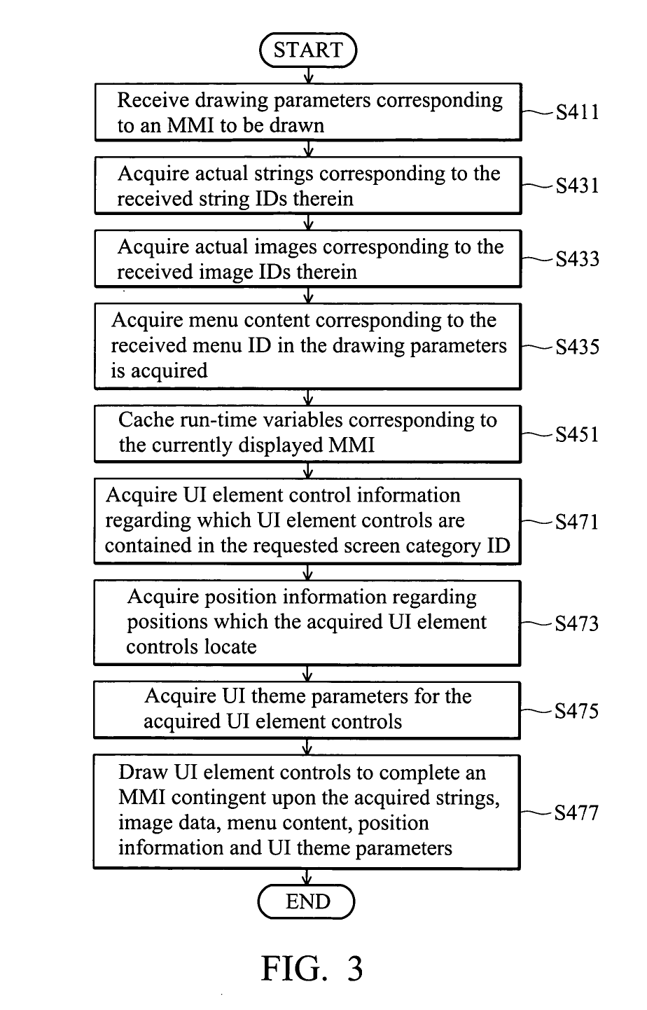

FIG. 3 is a flowchart showing an embodiment of a method for interface management, performed by the category manager core engine 3310. In step S411, drawing parameters corresponding to an MMI layout to be drawn are received, comprising information regarding a function ID, a category screen ID, and string IDs corresponding to predefined strings, image IDs corresponding to predefined images, and/or menu ID associated to a predefined menu item set. The function ID indicates a source calling function (i.e. a caller function), such as a “calls” function, a “messages” function, a phone book function, and so on, resident in the application layer 3100. The category screen ID indicates that the MMI layout to be drawn is based on a category screen corresponding to the category screen ID. The string IDs, image IDs, and/or a menu ID indicates the content for UI element controls contained in the MMI layout. In step S431, if required, actual strings corresponding to the received string IDs in the drawing parameters are acquired. Step S431 may acquire these strings via the string management sub-module 3331 (as shown in FIG. 2). In step S433, if required, actual images corresponding to the received image IDs in the drawing parameters are acquired. Step S433 may acquire these images via the image management sub-module 3333 (as shown in FIG. 2). In step S435, if required, menu content such as the number of menu items, and hide properties, string IDs and images IDs for menu items, corresponding to the received menu ID in the drawing parameters is acquired. Step S435 may acquire the content of a designated menu via the menu management sub-module 3335 (as shown in FIG. 2). Those skilled in the art will realize that the acquired actual strings, image data and menu content can be stored in a memory device with a proprietary data structure for subsequent process. In order to support a screen roll back feature, in step S451, run-time variables corresponding to the currently displayed MMI layout are cached, or run-time variables corresponding to the prior displayed MMI layout are restored. Step S451 may perform the above operations via the history management module 3370 (as shown in FIG. 2). In step S471, UI element control information regarding which UI element controls are contained in the requested category screen ID is acquired. Step S471 may acquire the UI element control information via the UI control management sub-module 3353 (as shown in FIG. 2). In step S473, position information regarding positions which the acquired UI element controls locate is acquired. Step S473 may acquire the UI element control information via the UI control management sub-module 3353 (as shown in FIG. 2). In step S475, UI theme parameters for the acquired UI element controls are acquired. Step S475 may acquire the UI theme parameters via the UI theme sub-module 3357 (as shown in FIG. 2). In step S477, UI element controls are drawn to complete an MMI layout contingent upon the acquired strings, image data, menu content, position information and UI theme parameters. Step S477 may draw certain UI element controls determined by step S471 via the UI engine 3351 (as shown in FIG. 2).

Details of steps S431 to S435 are further described in the following, accompanied descriptions of the resource management module 3330 (as shown in FIG. 2). Referring to FIG. 2, the resource management module 3330 manages the resources, such as strings, images and menus, to be displayed in an MMI layout. Such resources in the application layer 3100 are referenced by unique IDs. Functions in the application layer 3100 may follow certain proprietary rules to encode these IDs to identify specific resources. Each function in the application layer 3100 may have a predefined range of code segments, such as 0x1100 to 0x11FF, or particular portions of strings, such as “STR_PHONE_BOOK_” and “STR_MESSAGES_”, to identify its shared resources.

The string management sub-module 3331 resolves string IDs provided from the application layer 3100 to actual strings by a string database. The string database comprises two tables such as a string map table and a string resource table. The string resource table is a linear array in which all strings are stored successively in fixed or variable lengths and are referred by indices. The string map table contains multiple mappings respectively for a relationship between a string ID and an index. These indices in the string map table, also called foreign keys, provide association links to access actual strings stored in the string resource table. The string management sub-module 3331 first acquires an index for a string ID from the string map table, and subsequently acquires an actual string by retrieving data corresponding to the acquired index from the string resource table. The acquired string will be transmitted to the UI management module 3350 for display.

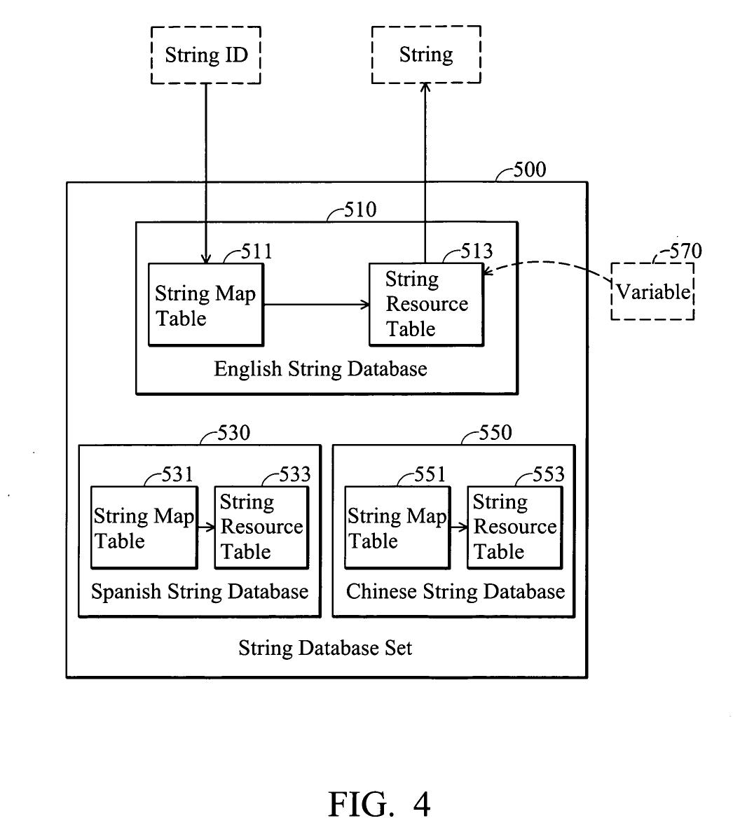

In order to support a multi-language feature, there may be more than one string database, and each string database comprises the described two tables. A variable containing information regarding which language is adopted may be stored in the memory device. The string management sub-module 3331 may further detects the stored variable and accordingly selects a relevant string database to acquire actual strings corresponding to the provided string IDs. FIG. 4 is a diagram of three exemplary string databases supporting a multi-language feature, utilized by the string management sub-module 3331 (as shown in FIG. 2). A string database set 500 contains three string database such as English, Spanish and Chinese string databases 510, 530 and 550, for different languages. Each string database comprises a string map table 511, 531 or 551, and a string resource table 513, 533 or 553. A variable 570 provides information indicating that English is the current language, enables the string management sub-module 3331 to acquire actual strings from the English string database 510.

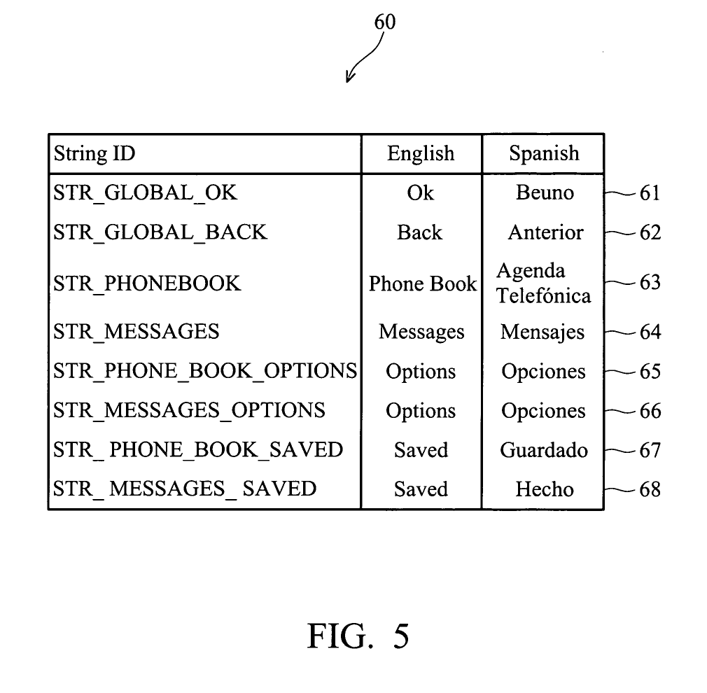

FIG. 5 is a diagram of an exemplary conceptual table 60 containing mappings between string IDs and actual strings in different languages. It will be understood that the logical table 60 is a logical expression but the physical data structure is provided in the string database set 500 (as shown in FIG. 4). Rows 61-68 respectively express mappings between string IDs, English strings and Spanish strings. Referring to rows 61 and 62, string IDs “STR_GLOBAL_OK” and “STR_GLOBAL_BACK”, globally used across functions, respectively refer to a string “Ok” in English and a string “Bueno” in Spanish, as well as, a string “Back” in English and a string “Anterior” in Spanish. Referring to row 63, “STR_PHONEBOOK” refers to a string “Phone Book” in English and a string “Agenda Telefónica” in Spanish, utilized in a function “PHONE BOOK”. Referring to row 64, “STR_MESSAGES” refers to a string “Messages” in English and a string “Mensajes” in Spanish, utilized in a function “Messages”. Referring to rows 65 and 66, two string IDs “STR_PHONE_BOOK_OPTIONS” and “STR_MESSAGES_OPTIONS” respectively used in the described functions (i.e. the function “Phone Book” and function “Messages”) all refer to the same string “Options” in English and the same string “Opciones” in Spanish. Note that there will be a single string “Options” or “Opciones” stored in the string resource table 513 or the string resource table 533 to save storage space. Referring to rows 67 and 68, two string IDs “STR_PHONE_BOOK_SAVED” and “STR_MESSAGES_SAVED” respetively_used in the above functions refer to the same string “Saved” in English but different strings “Guardado” and “Hecho” in Spanish. Note that there will be a single string “Options”, “Opciones” or “Saved” stored in the string resource table 513 or the string resource table 533 to save storage space of these string resource table.

Because these shared strings are referenced and retrieved by string IDs, costs related to modifying code written in functions in the application layer 3100 when any resource is updated, can be eliminated. For example, when a string “MP3 player” is replaced with “Audio player”, only the corresponding string in a string resource table is updated, but no code need be rewritten in the functions in the application layer 3100. It will be understood that such mapping mechanism provides reusability of actual strings across different functions and within a single function to save storage space in the memory device, particularly in a flash memory.

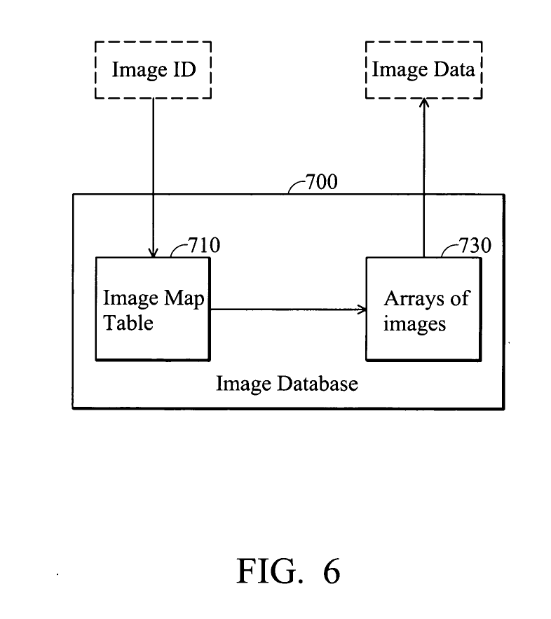

Referring back to FIG. 2, the image management sub-module 3333 resolves image IDs provided from the application layer 3100 to actual images by an image database. FIG. 6 is a diagram of an exemplary image database, utilized by the image management sub-module 3333 (as shown in FIG. 2). The image database 700 comprises an image map table 710 and arrays of images 730 referred by addresses, each array containing a header of six bytes followed by the actual image data. The header may comprise information regarding an image format such as BMP, JPEG, GIF and the like, the height and width for the following actual image data. The image map table 710 contains multiple mappings individually for a relationship between an image ID and an address for an array of image. The image management sub-module 3333 first acquires an address for an image ID from the image map table 710, and subsequently acquires actual image data by retrieving the array of the acquired address from the arrays of images 730. The acquired image data will be transmitted to the UI management module 3350 (as shown in FIG. 2) for display. Note that the image database 700 may support various types of images, such as BMP, JPEG and GIF, as the information about the image type for each image data is recorded in the header, thus, the stored image data can be displayed by various functions such as a flash player, image viewer and the like, with relevant image decoders.

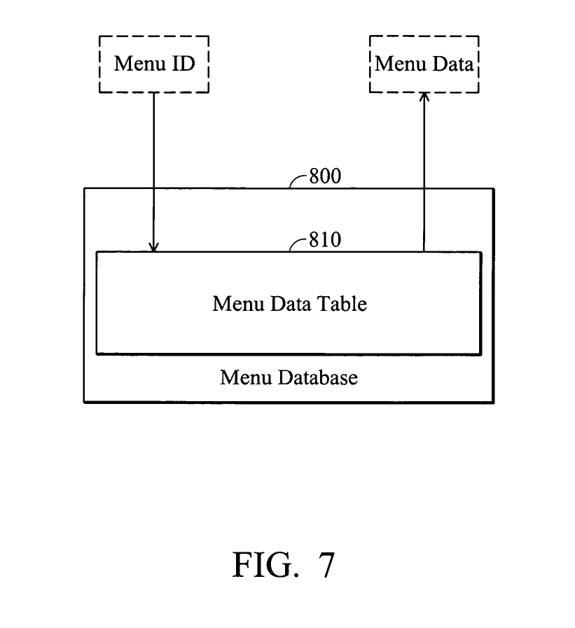

The menu management sub-module 3335 receives a menu ID provided from the application layer 3100 and retrieves actual menu data from a menu database. FIG. 7 is a diagram of an exemplary menu database, utilized by the menu management sub-module 3335 (as shown in FIG. 2). The menu database 800 comprises a menu data table 810. Menus can be referred to as collections of menu items, and these menu items can be navigated to facilitate users to choose one of them. These menu items may be displayed in various styles such as list (as shown in 221 of FIG. 1a), circular graphic (as shown in 241 of FIG. 1b), page, matrix or similar. It will be understood that the application layer 3100 (as shown in FIG. 2) contains no code for manipulating menus such as highlighting a menu item when menu items are navigated or similar.

The menu data table 810 comprises multiple menu data records, and each menu data record corresponds to a specific menu content belonging to a particular menu ID. Each menu data record may contain information regarding a display style; a total number of menu items (i.e. number of children), menu item sequence, hide properties, string IDs, image IDs, the associated functions (resident in the application layer 3100) for menu items, or others. The display style indicates which style such as list, circular graphic, page, matrix or similar, is utilized to display. When the hide property for a menu item is set to “true” or similar, it results in the menu item is not displayed. Each menu item, typically, may associate with a string and/or an image for representation. A menu item may further correspond to a function, and when the menu item is highlighted and selected, the associated function is triggered. Menu item sequence indicates the order of menu items placed from the top to the bottom, from upper-left to the lower-right or similar in a display region. It will be understood that, when the content of menus is changed, relevant information stored in the menu data table 810, instead of code written in functions in the application layer 3100, is updated.

When detecting a string ID or an image ID in the acquired menu data record, the menu management sub-module 3335 (as shown in FIG. 2) acquires an actual string corresponding to the detected string ID, or actual image data corresponding to the detected image ID via the string management sub-module 3331 or the image management module 3335.

The menu management sub-module 3335 also handles events such as move up, move down, page up, page down, short cut key, or similar, relating to menus. When the move up or the move down event is triggered, the menu management sub-module 3335 highlights the prior or the next menu item. The display may not have enough space to display all menu items. Thus, the menu items may be divided into several pages and the menu management sub-module 3335 displays menu items one page at one time. When the page up or the page down event is triggered, the menu management sub-module 3335 displays menu items of the prior or the next page. When the short cut key event comprising information regarding a particular key number is pressed on the key pad of the portable electronic device, the menu management sub-module 3335 makes a function call to a designated function resident in the application layer 3100 contingent upon the key number, where the key number preferably indicates a serial number of a particular menu item.

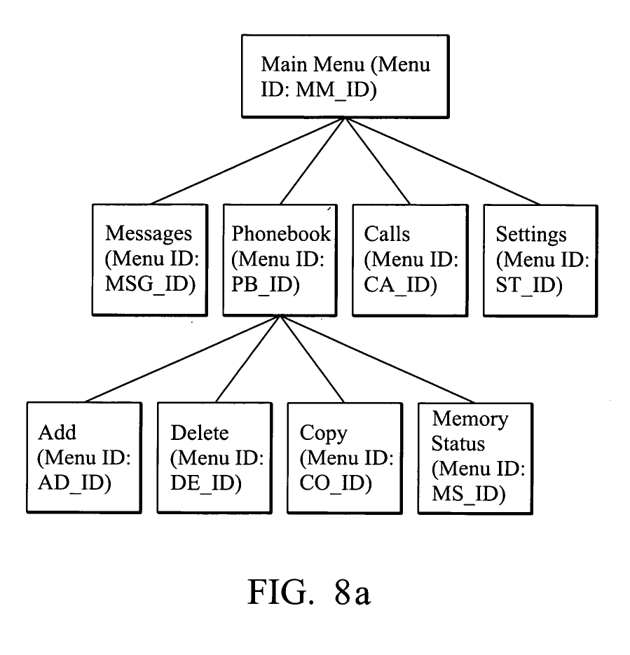

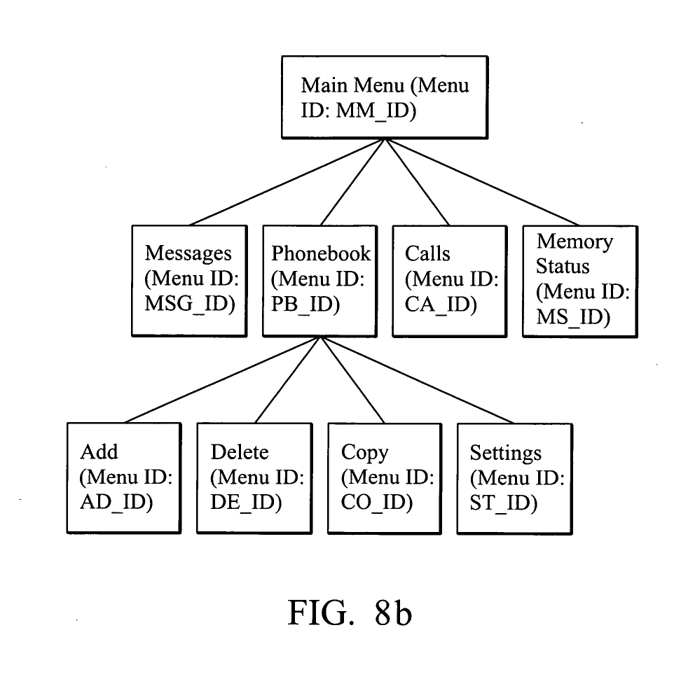

The menu data table 810 also stores information regarding the tree structure of menu items by menu item sequences in menu data records. FIG. 8a is a diagram of tree structure of exemplary menu items. A menu “Main Menu” with a menu ID “MM_ID” contains four menu items “Messages”, “Phonebook”, “Calls” and “Settings” in sequence, where the menu item sequence for the menu “Main Menu” is “MSG_ID, PB_ID, CA_ID, ST_ID”. Additionally, when a function corresponding to the menu item “Phonebook” is triggered, another menu composed of four menu items “Add”, “Delete”, “Copy” and “Memory Status” is displayed, where the menu item sequence for the menu “Phonebook” is “AD_ID, DE_ID, CO_ID, MS_ID”. When exchange of the positions of menu items “Memory Status” and “Settings” located in such a menu tree is desired as shown in FIG. 8b, the original menu item sequence for the menu “Main Menu” can be replaced with “MSG_ID, PB_ID, CA_ID, MS_ID” and replace the original menu item sequence for the menu “Phonebook” with “AD_ID, DE_ID, CO_ID, ST_ID”, without modifying code in the functions in the application layer 3100.

Details of step S451 (as shown in FIG. 3) are further described in the following, accompanying with descriptions of the history management module 3370 (as shown in FIG. 2). Referring to FIG. 2, in order to support the screen roll back feature, the history management module 3370, before leaving an MMI layout (i.e. the currently displayed MMI layout) and displaying another MMI layout, caches all run-time variables such as the highlighted menu item, input data, or other data for function execution, corresponding to the currently displayed MMI layout. The cached run-time variables are restored when a historical MMI layout, i.e. the previously displayed MMI layout, is required to be returned. For example, referring to FIG. 8a, when an MMI layout containing a menu “Phonebook” is prepared to be displayed, a run-time variable storing information regarding that a menu item “Phonebook” is highlighted is pushed in a stack by the history management module 3370. When an MMI layout containing the historical menu “Main Menu” is prepared to be returned, the stored run-time variable is popped out of the stack by the history management module 3370. Thereafter, the category manager core engine 3310 displays an MMI layout containing a menu “Main Menu” comprising a highlighted menu item “Phonebook” contingent upon the popped-out run-time variables. Those skilled in the art will recognize that access to run-time variables of MMI layouts can also be achieved by an array, list or other data structures in a last-in-first-out (LIFO) basis.

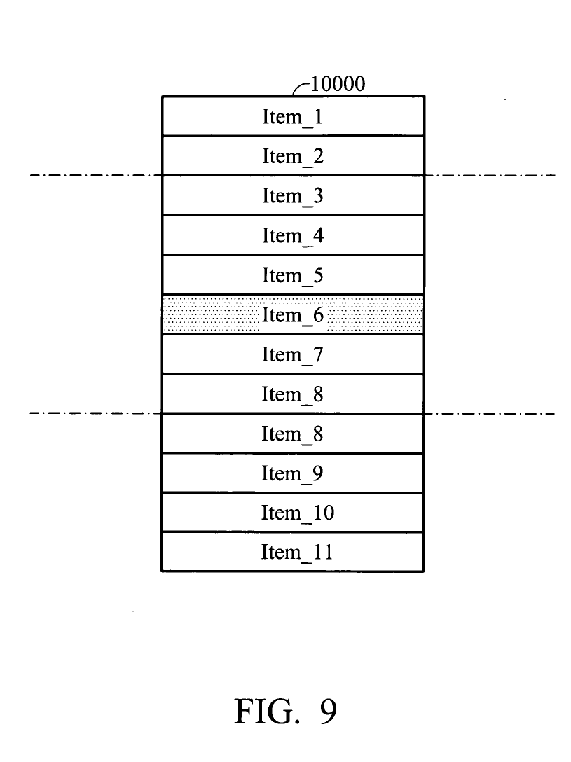

The run-time variables may be divided into two categories: entry function ID and UI buffer. The entry function ID corresponds to a function to be called when returning to the originally displayed MMI layout. The UI buffer may contain a first menu item ID corresponding to a menu item originally displayed on the top of the menu, a last menu item ID corresponding to a menu item originally displayed at the bottom of the menu, and a select item ID corresponding to a menu item originally being highlighted. FIG. 9 is a diagram illustrating an exemplary UI buffer corresponding to a menu to be displayed. There are eleven menu items with menu item IDs ranging from “Item_1” to “Item_11” in a menu 10000. In an instant, six menu items with IDs ranging from “Item_3” to “Item_8” are displayed on the display and a menu item with ID “Item_6” is highlighted, and another MMI layout is required to be displayed. Thus, a UI buffer comprising a first menu item ID “Item^{—}3”, a last menu item ID “Item_8” and a select item ID “Item_6” is cached. Note that different category screens may have different content in the UI buffers to be cached.

The run-time variables corresponding to the currently displayed MMI is cached when an asynchronous event indicating that a phone call is incoming, a short message (SM) is received, or similar, has occurred, or when a signal indicating that a function is to be executed is received from a key corresponding to a soft key (as shown in 223 of FIG. 1a or 243 of FIG. 1b) on the key pad. It will be understood that, when the display is a touch pad, a signal indicating that a designated function is to be executed can also be received from a display region 217 (as shown in FIG. 1a) or 237 (as shown in FIG. 1b). The cached run-time variables are popped out of the stack when the received asynchronous event is complete or terminated, or when a signal indicating that the previous MMI layout is to be returned is received from a key corresponding to a soft key (as shown in 225 of FIG. 1a or 245 of FIG. 1b) on the key pad. It will be understood that, when the display is a touch pad, a signal indicating that the previous MMI layout is to be returned can also be received from a display region 215 (as shown in FIG. 1a) or 235 (as shown in FIG. 1b).

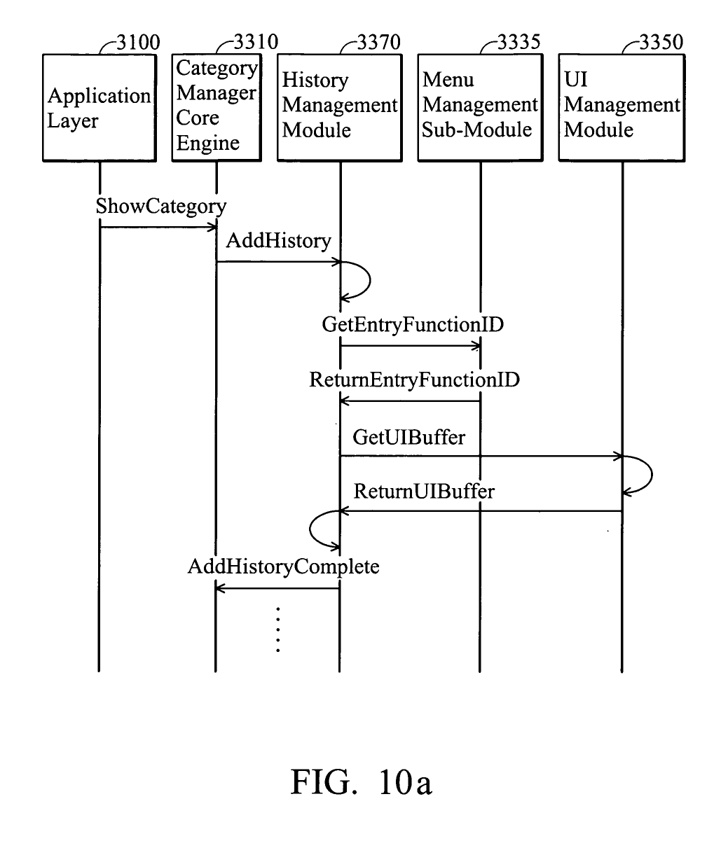

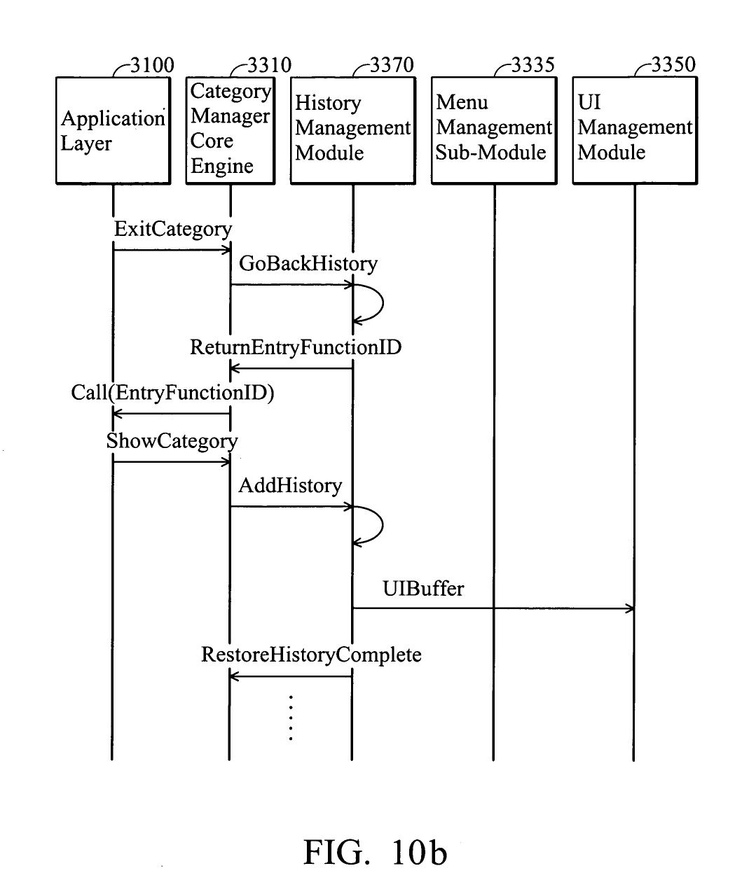

FIG. 10a is an exemplary sequence diagram for caching run-time variables for an MMI layout. When receiving a function call ShowCategory( ) from the history management module 3370, the category manager core engine 3310 makes a function call AddHistory( ) to the history management module 3370 to cache relevant run-time variables for the currently displayed MMI layout. Thereafter, the history management module 3370 acquires the entry function ID via the menu management sub-module 3335 and UI buffer for all UI element controls via the UI management module 3350, and push the acquired run-time variables in the stack.

FIG. 10b is an exemplary sequence diagram for restoring run-time variables for the previously cached MMI layout. When the category manager core engine 3310 receives a function call ExitCategory( ) from the history management module 3370, issue a function call GoBackHistory( ) to the history management module 3370 to restore run-time variables for the prior displayed MMI layout by popping out of the stack. Note that the popped-out UI buffer may be temporarily cached in the memory device for subsequent process. The restored entry function ID is returned to the category manager core engine 3310. Thereafter the category manager core engine 3310 makes a function call to a function corresponding to the restored entry function ID. The function resident in the application layer 3100 then makes a function call ShowCategory( ) to the category manager core engine 3310 to draw an MMI layout. The category manager core engine 3310 makes a function call AddHistory( ) to the history management module 3370 to cache relevant run-time variables for the currently displayed MMI layout. The history management module 3370, however, detects that the called function corresponds to the previously restored entry function ID and omits operations for caching run-time variables. Thereafter, the history management module 3370 transmits the temporarily cached UI buffer to relevant UI element controls and replies with a RestoreHistoryComplete message to the category manager core engine 3310.

Details of steps S471 to S477 (as shown in FIG. 3) are further described in the following, accompanied descriptions of the UI management module 3350 (as shown in FIG. 2). Referring to FIG. 2, the UI management module 3350 draws an MMI layout based on the received category screen ID, actual strings, image data and/or the pertained run-time variables. The UI engine 3351 manages the UI control management sub-module 3353, UI coordinate sub-module 3355 and UI theme sub-module 3357 to acquire drawing details for the requested category screen ID with relevant drawing parameters. Thereafter, the UI engine 3351 gathers relevant UI element controls such as a title control, a menu control, a button bar control, a status bar control, and the like to render an MMI layout on the display contingent upon the acquired drawing details.

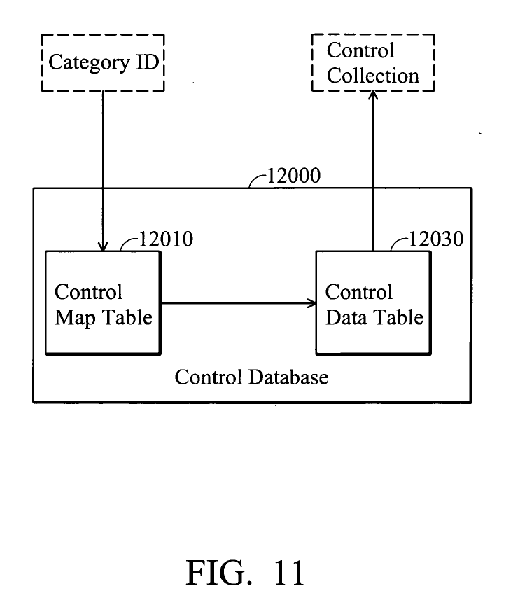

The UI control management sub-module 3353 acquires information regarding which UI element controls are contained in the requested category screen ID from a control database. FIG. 11 is a diagram of an exemplary control database 12000, utilized by the UI control management sub-module 3353. The control database 12000 comprises a control map table 12010 and a control data table 12030 containing multiple UI control collections referred by indices. Each UI control collection comprises information regarding multiple UI element controls and a total number of the contained UI element controls. The control map table 12010 contains multiple mappings individually for a relationship between a category screen ID and an index. These indices in the control map table 12010, also called foreign keys, provide association links to control collections stored in the control data table 12030. The UI control management sub-module 3353 (as shown in FIG. 2) first acquires an index for the received category screen ID from the control map table 12010, and subsequently acquires an UI control collection of the acquired index from the control data table 12030. The acquired UI control collection will be transmitted to the UI engine 3351 (as shown in FIG. 2). For example, referring to FIG. 1a, the category screen 210 with a category screen ID “LIST_MAIN_MENU” corresponds to a UI control collection represented by [3, CONTROL_TITLE, CONTROL_LIST, CONTROL_BUTTON_BAR]. The UI control collection comprises information indicating that there are three UI element controls for the category screen 210: a title control “CONTROL_TITLE”, a list menu control “CONTROL_LIST” and a button bar control “CONTROL_BUTTON_BAR”. It will be understood that, when the content of the category screen is changed, only relevant information stored in the control data table 12030, instead of code written in functions in the application layer 3100, is updated.

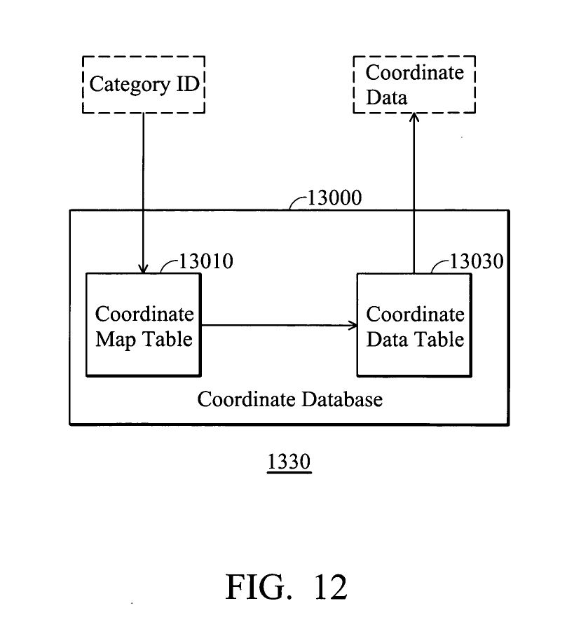

The UI coordinate sub-module 3353 acquires information regarding positions which the acquired UI element controls locate on the display from a coordinate database, such position information may be represented by starting coordinates, element widths and heights. For example, position information corresponding to a title control may comprise a starting coordinate (0,0), an element width of 300 pixels and an element height of 50 pixels. FIG. 12 is a diagram of an exemplary coordinate database 13000, utilized by the UI coordinate sub-module 3355. The coordinate database 13000 comprises a coordinate map table 13010 and a coordinate data table 13030 containing multiple UI coordinate collections referred by indices. Each UI coordinate collection comprises information regarding starting coordinates, element widths and element heights for UI element controls corresponding to a category screen ID (or a category screen ID plus a function ID). It will be understood that the UI coordinate collection may also comprise information regarding a starting coordinate (i.e. an upper-left position for a UI element control), an interface width and an interface height for an MMI layout corresponding to a category screen ID (or a category screen ID plus a function ID). The coordinate map table 13010 contains multiple mappings individually for a relationship between a category screen ID (or a category screen ID plus a function ID) and an index. These indices in the coordinate map table 13010, also called foreign keys, provide association links to coordinate collections stored in the coordinate data table 13030. The UI coordinate sub-module 3355 (as shown in FIG. 2) first acquires an index for the received category screen ID (or the received category screen ID plus function ID) from the control map table 13010, and subsequently acquires an UI coordinate collection of the acquired index from the control data table 13030. The acquired UI coordinate collection is transmitted to the UI engine 3351 (as shown in FIG. 2). For example, referring to FIG. 1a, the category screen 210 with a category screen ID “LIST_MAIN_MENU” corresponds to a UI coordinate collection represented in the following.

[

0, 0, LCD_WIDTH, LCD_HEIGHT (Category Coordinates),
0, 0, LCD_WIDTH, TITLE_HEIGHT (Title Coordinates),
0, TITLE_HEIGHT − 1, LCD_WIDTH,
LCD_HEIGHT − TITLE_HEIGHT −
BUTTON_HEIGHT (List Coordinates),
0, LCD_HEIGHT − BUTTON_HEIGHT −
1, LCD_WIDTH,
BUTTON_HEIGHT (Button Bar Coordinates)

]

Wherein, “LCD WIDTH”, “LCD_HEIGHT”, “TITLE_HEIGHT” and “BUTTON_HEIGHT” are constants respectively indicating width, height for the display, height for a title control and height for a button control containing soft keys. It will be understood that, when the position of a particular UI element control is changed, only relevant information stored in the coordinate data table 13030, instead of code written in functions, is updated.

Referring to FIG. 2, the UI theme sub-module 3357 acquires UI theme parameters such as background color, font color, border style, font style and the like, from a theme database for a specific UI element control ID provided from the UI engine 3351. As mentioned, one category screen contains several UI element controls, such as a title control, a menu control, a button bar control, a status bar control, and one UI element control may contains three types of data, such as strings, images and menus. One UI element control corresponds to a UI element control ID, and the UI theme sub-module 3357 acquires UI theme parameters from the theme database according to the UI element control ID. These UI theme parameters affect “look and feel” of the UI element controls so as to generate a displayed MMI layout with different “look and feel.”

The theme database comprises two tables such as a theme map table and a theme data table. The theme data table stores theme parameters corresponding to each UI element control ID and referred by indices. The theme map table contains multiple mappings respectively for a relationship between a UI element control ID and an index. These indices in the theme map table, also called foreign keys, provide association links to UI theme parameters stored in the theme data table. The UI theme sub-module 3327 first acquires an index for a UI element control ID from the theme map table, and subsequently acquires theme parameters by retrieving data of the acquired index from the theme map table. The acquired UI theme parameters will be transmitted to the UI engine 3351.

In order to support a multi-theme feature, there may be more than one theme database, and each theme database comprises the two described tables. A variable containing information regarding which theme is adopted may be stored in the memory device of the portable electronic device. The UI theme sub-module 3357 may further detect the stored variable and accordingly select a relevant theme database to acquire relevant theme parameters by providing UI element control IDs. Those skilled in the art will realize that a specific UI theme may be predetermined across for all MMI layouts until the determination is updated, and UI themes may be varied by updating information in the variable.

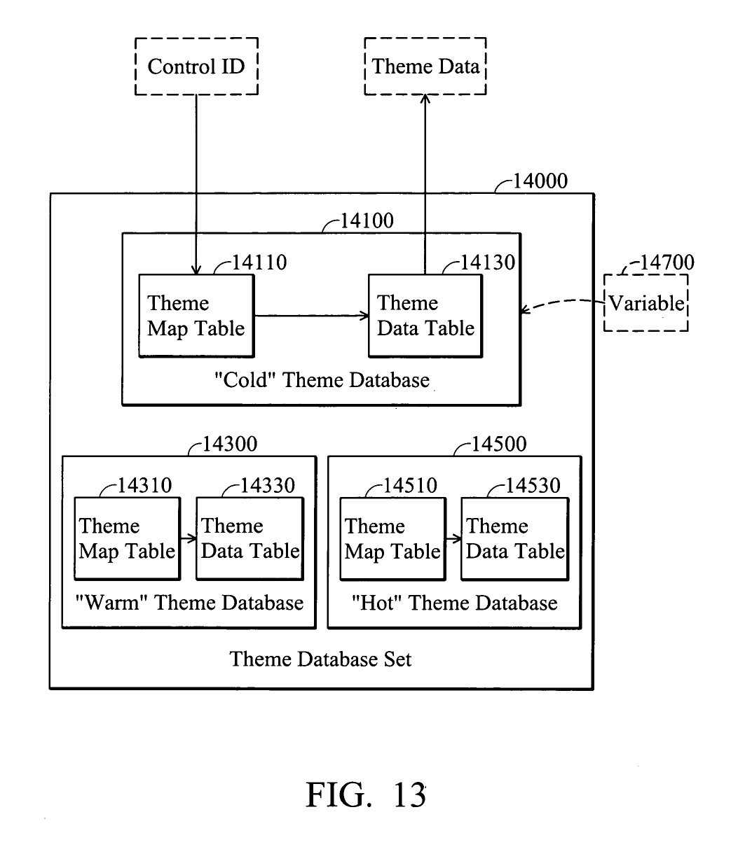

FIG. 13 is a diagram of three exemplary theme databases supporting the multi-theme feature, utilized by the UI theme sub-module 3357 (as shown in FIG. 2). A theme database set 14000 contains three theme databases such as “Cold”, “Warm” and “Hot” theme databases 14100, 14300 and 14500, for different themes. Each theme database comprises a theme map table 14110, 14310 or 14510, and a theme data table 14130, 14330 or 14530. For example, the “Cold” theme database 14100 may store information regarding that all UI element controls are displayed with a blue colored background, the “Warm” theme database 14300 may store information regarding that all UI element controls are displayed with a orange colored background, and the “Hot” theme database 14500 may store information regarding that all UI element controls are displayed with a red colored background. A variable 14700 provides information regarding “Cold” theme is currently adopted, enables the UI theme sub-module 3357 to acquire relevant theme parameters from the “Cold” theme database 14700. It will be understood that, when theme parameters of a particular UI element control is changed, only relevant information stored in a theme data table, instead of code written in functions, is updated.

The UI engine 3351 determines certain UI element controls to be drawn contingent upon information received from the UI control management sub-module 3353, and, according to the acquired drawing details requested from the resource management module 3330, the UI coordinate sub-module 3355 and UI theme sub-module 3357, draws each determined UI element control containing the relevant string, image data and/or menu content with UI theme parameters at a specific location on the display to complete an MMI layout.

LCD size utilized to display a specific MMI typically dramatically affects drawing details of category screens. It is easy to deploy category screens to displays with another LCD size by modifying content of the control database 12000 (as shown in FIG. 11), coordinate database 1330 (as shown in FIG. 12) and theme database set 14000 (as shown in FIG. 13). For example, when a design engineer intend to deploy the category manager 3300 (as shown in FIG. 2) suitable for a mobile phone with LCD size of 128×128 to another mobile phone with LCD size 176×220. Additional UI element controls may be displayed on such display with increased LCD size for category screens, or the size of UI element controls in category screens, such as a title control, a menu control, a button bar control, a status bar control or similar, may be increased for added clarity.

The control database 12000 may be modified to insert additional UI element controls into the control data table 12030 (as shown in FIG. 11) with additional mappings in the control map table (as shown in FIG. 11) for each of relevant category IDs. It will be understood that coordinate information corresponding to the newly inserted UI element controls is also inserted into the coordinate database 13000 (as shown in FIG. 12), as well as, theme information corresponding to the newly inserted UI element controls is also inserted into the theme database set 14000 (as shown in FIG. 13).

In order to clearly display strings in UI element controls, the heights of UI element controls may be increased and the related font style may be changed. Such modifications are easy to be achieved by updating the corresponding coordinate information and theme information stored in the coordinate database 13000 and the theme database set 14000.

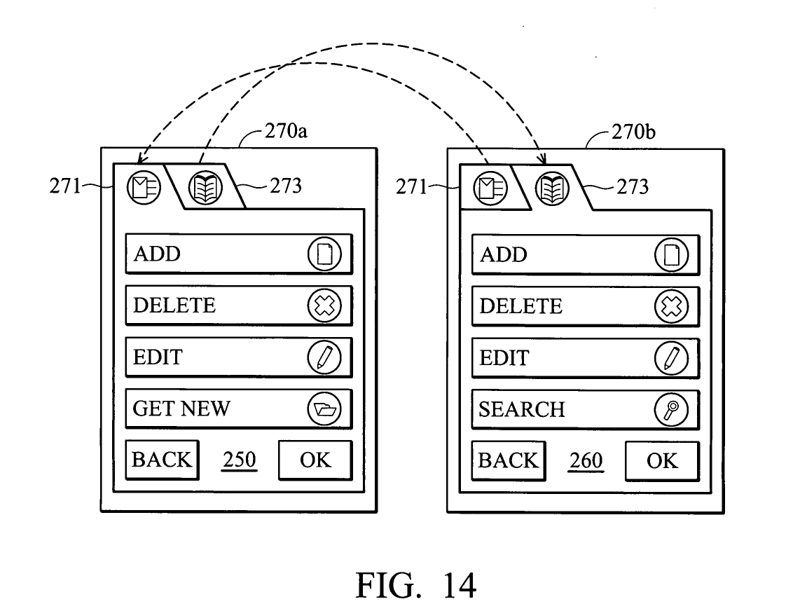

Multiple MMIs based on at least one category screen may be further contained in a macro MMI such as a tab pane, and one MMI can be switched to another by pressing of tabs of the tab pane on displays of a portable electronic device, a left or right button on a keypad of a portable electronic device. FIG. 14 is a diagram of exemplary switchings between two MMIs. A tab pane 270 contains two menus 250 and 260 respectively corresponding to two functions “MESSAGES” and “PHONEBOOK”. In the left MMI 270a, the tab pane contains the “MESSAGES” menu 250, as well as, in the right MMI 270b, the tab pane 270b contains the “PHONEBOOK” menu 260. Menus 250 and 260 can be switched by pressing of tabs of the tab pane on displays of a portable electronic device, a left or right button on a keypad of a portable electronic device.

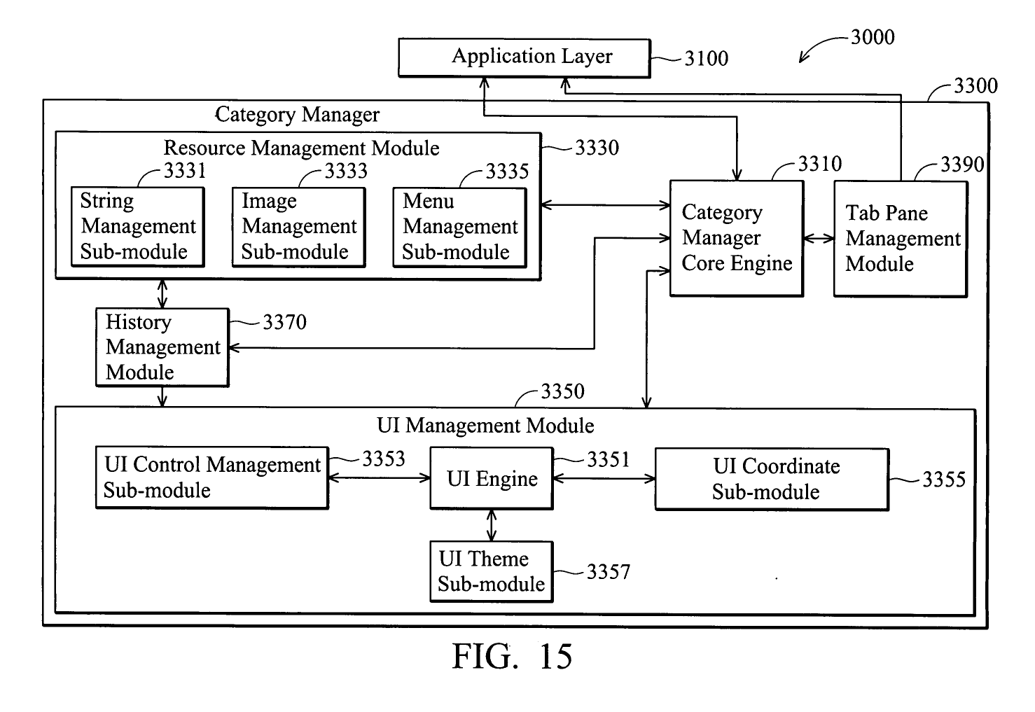

FIG. 15 is a diagram of the software architecture of an embodiment of an interface management system, additionally comprising a tab pane management module 3390. Tab pane management module 3390 shows parent functions such as “MESSAGES”, “PHONEBOOK” or others, in tabs as icons (e.g. 271 and 273 of FIG. 14). Each of the parent functions may have its string, image, and type for being shown as an icon, and the application constitute the first layer of data in the tab pane (e.g. 270a or 270b of FIG. 14). The parent functions have certain common children applications, such as “ADD”, “DELETE”, “EDIT” or similar, and the children functions may have String IDs and Image IDs and are shown as a menu. What is more, the children functions are presented as components on screen layout, which belongs to one of the category screen. In the tab pane management module 3390, each of the functions has corresponding image and string.

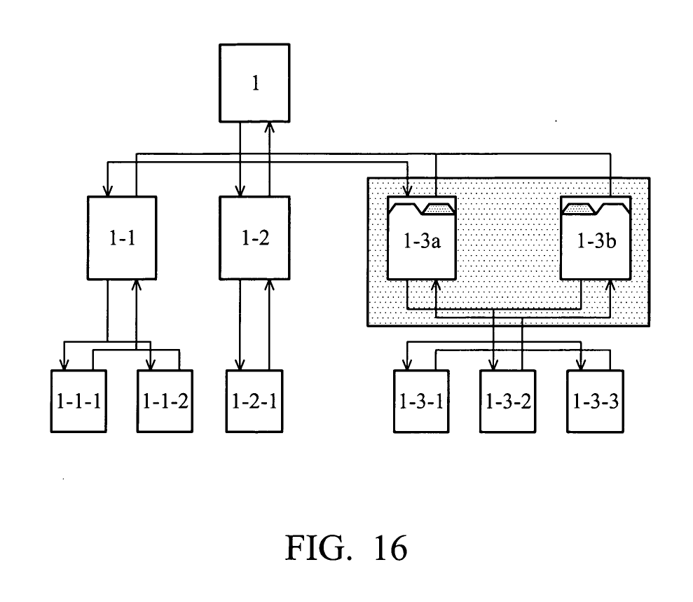

Different parent functions may share certain common children functions and share certain common category screens. Tab pane manager shows the first and second layers of data on the same screen layout, and tab pane may comprise a display attribute for a menu, such as page, list and matrix. The functions are organized as layers. FIG. 16 is a diagram of an exemplary layer structure. Layers 1-3a and 1-3b are organized as a tab pane. The parent functions are in the first layer such as 1-3a and 1-3b, while the children ones are second, such as 1-3-1, 1-3-2 and 1-3-3.

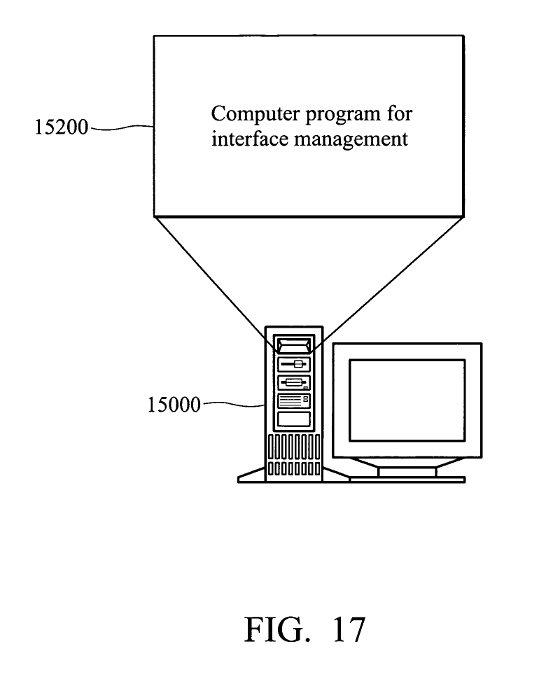

Also disclosed is a storage medium as shown in FIG. 17 storing a computer program 15200 providing the disclosed embodiment of the method for interface management. The computer program product includes a storage medium 15000 having computer readable program code therein for use in a portable electronic device.

Interface management systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a portable electronic device, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a machine, such as a portable electronic device, the machine becomes an apparatus for practicing the invention. When implemented on a general-purpose processor, the program code combines with the processor to provide a unique apparatus that operates analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. The invention is not limited to merely test or simulation applications. Any applications relating to cross-platform message exchanging should be covered by the scope of the invention. Therefore, the scope of the invention shall be defined and protected by the following claims and their equivalents.

What is claimed is:

1. A method for interface management employed in a portable electronic device, comprising:
receiving a category screen identity (ID) from a function resident in an application layer, the category screen ID corresponding to one screen layout among a plurality of screen layouts;
determining drawing details corresponding to the received category screen ID; and
drawing an interface contingent upon the determined drawing details on a display of the portable electronic device.

2. The method of claim 1 wherein the screen layout comprises a user interface (UI) element control, the method further comprising:
receiving a string ID from the function;
acquiring an actual string corresponding to the received string ID; and
drawing the acquired string on the UI element control in the interface.

3. The method of claim 1 wherein the screen layout comprises a user interface (UI) element control, the method further comprising:
receiving a string ID from the function;
determining one string database among a plurality of string databases, each string database stores the actual strings in one language among a plurality of languages;
acquiring an actual string corresponding to the received string ID from the determined string database; and
drawing the acquired string on the UI element control in the interface.

4. The method of claim 1 wherein the screen layout comprises a user interface (UI) element control, the method further comprising:
receiving an image ID from the function;
acquiring actual image data corresponding to the received image ID; and
drawing an image corresponding to the acquired image data on the UI element control in the interface.

5. The method of claim 1 wherein the screen layout comprises a menu control, the method further comprising:
receiving a menu ID from the function;
acquiring actual menu data corresponding to the received menu ID; and
drawing the menu control corresponding to the acquired menu data in the interface, the menu control utilized to browse a plurality of menu items therein and call a particular function resident in the application layer when one of the menu items is selected.

6. The method of claim 5 wherein the acquired menu data comprises menu item data belonging to the received menu ID, the menu item data corresponds to one of the menu items comprising a string ID or an image ID, the method comprising:
acquiring an actual string corresponding to the received string ID;
acquiring actual image data corresponding to the received image ID; and
drawing the acquired string and an image corresponding to the acquired image data on the corresponding menu item.

7. The method of claim 1 further comprising:
acquiring a plurality of run-time variables utilized in the currently displayed interface before determining the drawing details; and
caching the acquired run-time variables in a data structure in a last-in-first-out (LIFO) basis.

8. The method of claim 1 further comprising:
determining that the function ID is the same as a caller function ID cached in the top of a data structure in a last-in-first-out (LIFO) basis;
acquiring a plurality of run-time variables corresponding to caller function ID from the top of the data structure; and
drawing the interface contingent upon the acquired run-time variables.

9. The method of claim 1 further comprising:
acquiring first information regarding that a UI element control is contained in the interface corresponding to the received category screen ID; and
drawing the interface containing the UI element control contingent upon the acquired first information.

10. The method of claim 9 further comprising:
acquiring second information regarding that the UI element control is located at a specific location; and
drawing the UI element control at the location contingent upon the acquired second information.

11. The method of claim 9 further comprising:
acquiring third information regarding that the UI element control is displayed using a UI theme parameter affecting the “look and feel” of the interface; and
drawing the UI element control using the UI theme parameter contingent upon the acquired third information.

12. The method of claim 11 wherein the UI theme parameter is a background color, a font color, a border style or a font style.

13. The method of claim 9 further comprising:
determining one UI theme database among a plurality of UI theme databases, each UI theme database storing second information regarding that the UI element control is displayed using a UI theme parameter affecting the “look and feel” of the interface;
acquiring the UI theme parameter from the determined UI theme database; and
drawing the UI element control using the UI theme parameter contingent upon the acquired second information.

14. The method of claim 9 further comprising:
acquiring a string or an image corresponding to the function; and
drawing a tab pane comprising the drew interface and a tab displaying the acquired string or image.

15. A machine-readable storage medium storing a computer program which, when executed, performs a method for interface management by a portable electronic device, the method comprising:
receiving a category screen identity (ID) from a function resident in an application layer, the category screen ID corresponding to one screen layout among a plurality of screen layouts;
determining drawing details corresponding to the received category screen ID; and
drawing an interface contingent upon the determined drawing details on a display of the portable electronic device.

16. A system for interface management employed in a portable electronic device, comprising:
an application layer comprising a plurality of functions; and
a category manager receiving a category screen identity (ID) from one function, determining drawing details corresponding to the received category screen ID, and drawing an interface contingent upon the determined drawing details on a display of the portable electronic device,
wherein the category screen ID corresponds to one screen layout among a plurality of screen layouts.

17. The system of claim 16 wherein the screen layout comprises a user interface (UI) element control, the category manager receives a string ID from the function, acquires an actual string corresponding to the received string ID and drawing the acquired string on the UI element control in the interface.

18. The system of claim 17 wherein the actual string is acquired from a string database comprising a string map table and a string data table via a string management sub-module, the string data table comprises the string reference by an index, the string map table comprises a mapping between the index and the actual string, and the string management sub-module acquires the index corresponding to the received string ID from the string map table and acquires the actual string corresponding to the acquired index from the string data table.

19. The system of claim 16 wherein the screen layout comprises a user interface (UI) element control, the category manager receives a string ID from the function, determines one string database among a plurality of string databases, acquires an actual string corresponding to the received string ID from the determined string database and draws the acquired string on the UI element control in the interface, and each string database stores the actual strings in one language among a plurality of languages.

20. The system of claim 16 wherein the screen layout comprises a user interface (UI) element control, and the category manager receives an image ID from the function, acquires actual image data corresponding to the received image ID and draws an image corresponding to the acquired image data on the UI element control in the interface.

21. The system of claim 20 wherein the actual image data is acquired from an image database comprising an image map table and an image data table via an image management sub-module, the image data table comprises the image data referenced by an index, the image map table comprises a mapping between the index and the actual image data, and the image management sub-module acquires the index corresponding to the received image ID from the string map table and acquires the actual image data corresponding to the acquired index from the image data table.

22. The system of claim 16 wherein the screen layout comprises a menu control, the category manager receives a menu ID from the function, acquires actual menu data corresponding to the received menu ID and draws the menu control corresponding to the acquired menu data in the interface, and the menu control is utilized to browse a plurality of menu items therein and call a particular function resident in the application layer when one of the menu items is selected.

23. The system of claim 22 wherein the acquired menu data comprises menu item data belonging to the received menu ID, the menu item data corresponds to one of the menu items comprising a string ID or an image ID, and the category manager acquires an actual string corresponding to the received string ID, acquires actual image data corresponding to the received image ID and draws the acquired string and an image corresponding to the acquired image data on the corresponding menu item.

24. The system of claim 16 wherein the category manager acquires a plurality of run-time variables utilized in the currently displayed interface before determining the drawing details and caches the acquired run-time variables in a data structure in a last-in-first-out (LIFO) basis.

25. The method of claim 16 wherein the category manager determines that the function ID is the same as a caller function ID cached in the top of a data structure in a last-in-first-out (LIFO) basis, acquires a plurality of run-time variables corresponding to caller function ID from the top of the data structure and draws the interface contingent upon acquired run-time variables.

26. The method of claim 16 wherein the category manager acquires first information regarding that a UI element control is contained in the interface corresponding to the received category screen ID and draws the interface containing the UI element control contingent upon the acquired first information.

27. The method of claim 26 wherein the category manager acquires second information regarding that the UI element control is located at a specific location, and draws the UI element control at the location contingent upon the acquired second information.

28. The method of claim 26 wherein the category manager acquires third information regarding that the UI element control is displayed using a UI theme parameter affecting the “look and feel” of the interface, and draws the UI element control using the UI theme parameter contingent upon the acquired third information.

29. The method of claim 28 wherein the UI theme parameter is a background color, a font color, a border style or a font style.

30. The system of claim 26 wherein the category manager determines one UI theme database among a plurality of UI theme databases, each UI theme database storing second information regarding that the UI element control is displayed using a UI theme parameter affecting the “look and feel” of the interface, and the category manager acquires the UI theme parameter from the determined UI theme database and draws the UI element control using the UI theme parameter contingent upon the acquired second information.

31. The system of claim 16 wherein the category manager acquires a string or an image corresponding to the function and draws a tab pane comprising the drew interface and a tab displaying the acquired string or image.
